(19) United States
(12) Patent Application Publication
(10) Pub. No.: US 2017/0286723 A1
(43) Pub. Date: Oct. 5, 2017

(54) Keyboard For Strong Password Input

(71) Applicant: Zhenxiong Zhou, Windsor (CA)

(72) Inventor: Zhenxiong Zhou, Windsor (CA)

(21) Appl. No.: 15/173,808

(22) Filed: Jun. 6, 2016

Related U.S. Application Data
(60) Provisional application No. 62/315,104, filed on Mar. 30, 2016.

(51) Int. Cl. G06F 21/83; G06F 21/46

(52) U.S. Cl. CPC G06F 21/83; G06F 21/46

(57) ABSTRACT

The present invention discloses a keyboard and method for inputting strong passwords. The method uses a set of numeric password keys on a keyboard for typing an easy-to-remember numeric password that is converted to a strong password through a key-mapping system. The key-mapping system comprises five 10-mode switches built in the keyboard for configuring a combination of strong password characters that is mapped to the numeric password keys when the switch modes are set. By using such a keyboard, an actual strong password is entered when typing a nominal numeric password through the mapped numeric password keys on the keyboard. The exemplary keyboards for embodying the invention include different types of physical keyboards and on-screen keyboards.

### CROSS-REFERENCE TO RELATED APPLICATIONS

This application claims the benefit of priority under 35 U.S.C. §119 based on U.S. Provisional Application No. 62/315,104, filed on Mar. 30, 2016.

### BACKGROUND OF THE INVENTION

The present invention relates generally to a device and method for password input and more specifically to a keyboard and method for inputting a strong password by using an easy-to-remember numeric password.

Nowadays more and more services for shopping, communicating, entertaining, gaming and banking are available on the Internet. Many of these services require a user to create a strong password for logging onto a network or website. A strong password combines both length and different types of characters like uppercase and lowercase letters, numbers and symbols. Memorizing these strong passwords is very difficult and annoying for most internet users.

Using a software program to remember the complex passwords is a common technical solution to assist users to recall those passwords. Such art is referred to the keyboard with programmable username and password keys proposed by U.S. Pat. No. 8,161,545 B2 issued to Dean A. Craine as an example. However, it is inconvenient for users to install a password program in multiple computing devices and to make an identical setting for logging onto the same websites through a desktop computer at work, a laptop computer at home or a mobile device at any time. To prevent passwords from being hacked is more worrisome problem when the passwords are kept in a computing device. When using a public or shared computer, it is difficult to correctly recall and input a password that is stored in a user's personal computer. Managing passwords through a cloud service can resolve the problem, but a user still needs to remember a password for logging onto the service.

As a result of the above problems, it is simpler and more practical to write down a password rather than to operate a program for memorizing the password. Therefore, there is a strong need to provide a simple method for inputting a strong password directly through a keyboard without storing the password anywhere.

### BRIEF SUMMARY OF THE INVENTION

The present invention is proposed to provide a keyboard and method for inputting an actual strong password by typing a nominal numeric password. A numeric password is easy to remember if it comes from a user's memorable information, such as a birthday. But the numeric password is not strong password because it is easily guessed and hacked. The general idea of the present invention is to convert an easy-to-remember numeric password into a strong password through a key-mapping system built in a keyboard.

The built-in key-mapping system has five 10-mode switches coupled to a set of numeric password keys on the keyboard. The system is able to configure a combination of strong password characters for mapping the numeric password keys by setting the switch modes, so that a nominal easy-to-remember numeric password typed through such mapped numeric password keys is converted to an actually entered strong password. In order to easily remember a setting of switch modes and to configure a unique combination of strong password characters, the switch modes are set by using a set of numbers associated to a user's personal confidential information. Because of the different configurations of the strong password characters, one strong password is different from another strong password even if they are entered by using the same nominal numeric password. Thus, it is secure and simple to input a strong password by using an easy-to-remember numeric password through such a keyboard. This is a main object and advantage of the present invention.

There are more advantages of the present invention that overcame the problems mentioned in the “Background of the Invention”. Firstly, the key-mapping system can be built in any keyboard, so that a user can set the same switch modes to input the same password for the same website through multiple computing devices. Secondly, there is nothing to worry about a password being stolen because no any password is stored anywhere. Thirdly, it is secure to input a password through a public or shared computer by using such a keyboard, because the configuration of numeric password keys on the keyboard can be cleared after completion of the password input. Finally, inputting a password through the configurable keys can prevent the password from being hacked by key logging.

### BRIEF DESCRIPTION OF THE DRAWINGS

This invention will be described in detail in reference to a sequence of drawings, a brief description of which follows:

FIG. 1 is a diagram illustrating a method for inputting an actual strong password by typing a nominal easy-to-remember numeric password through a key-mapping system with five 10-mode switches built in a keyboard, in accordance with the invention.

FIG. 2 is a preset 100-key character map of the built-in key-mapping system, in which each pair of key characters is assigned to one switch mode.

FIG. 3 is a diagram illustrating a circuit layout of a set of number keys coupled to five 10-mode switches on a physical keyboard and a 10×10 key matrix.

FIG. 4 is an illustrative standard keyboard showing five 10-mode mechanical switches installed above F1-F10 function keys and a row of numeric password keys merged into the F1-F10 keys, in accordance with embodiment 1 of the invention.

FIG. 5 is an illustrative compact keyboard showing five 10-mode digital switches installed above F1-F10 function keys and a row of numeric password keys merged into the F1-F10 keys, in accordance with embodiment 2 of the invention.

FIG. 6 is an illustrative keyboard with a configurable number keypad showing five 10-mode digital switches installed above the number keypad, in accordance with embodiment 3 of the invention.

FIG. 7 is an illustrative laptop keyboard showing five LCD displays installed above F1-F10 function keys and five pairs of “up-arrow” and “down-arrow” setting buttons merged into the F1-F10 keys, in accordance with embodiment 4 of the invention.

FIG. 8 is an illustrative on-screen numeric password keyboard comprising a row of numeric password keys and a row of five 10-mode switches, in accordance with embodiment 5 of the invention.

FIG. 9 is an illustrative on-screen numeric password keyboard comprising a matrix of numeric password keys and a column of five 10-mode switches, in accordance with embodiment 6 of the invention.

FIG. 10 is a diagram illustrating the switch, as depicted in FIG. 8 and FIG. 9, for mapping two associated numeric password keys through a background program.

### DETAILED DESCRIPTION OF THE INVENTION

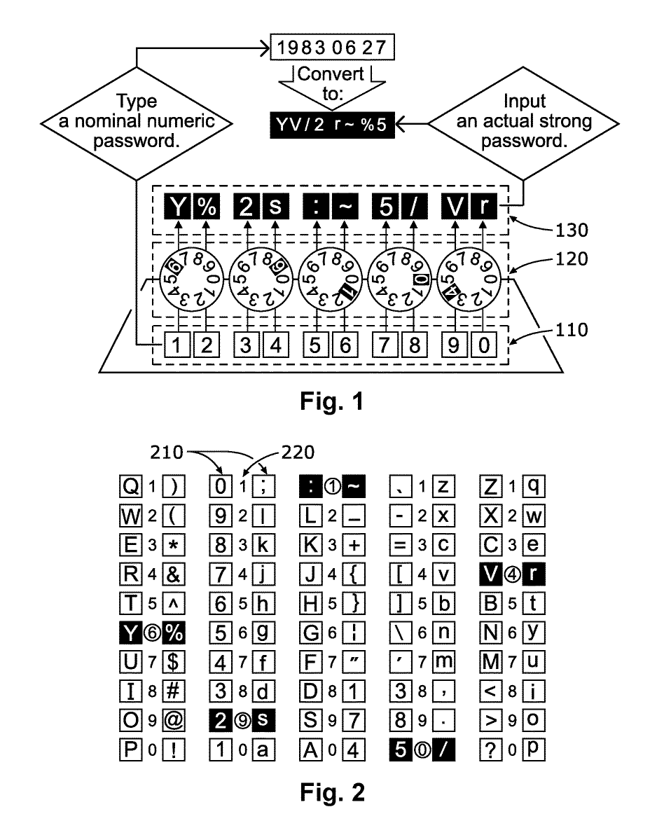

Referring to FIG. 1, the steps of the method for inputting a strong password is described in detail as the following, in accordance with the invention.

Step 1 is to have a set of numeric password keys 110 on a keyboard for typing a nominal easy-to-remember numeric password that is converted to an actual strong password, where the numbers 1-0 on the keycaps of the numeric password keys are nominal and their actual key characters are configurable.

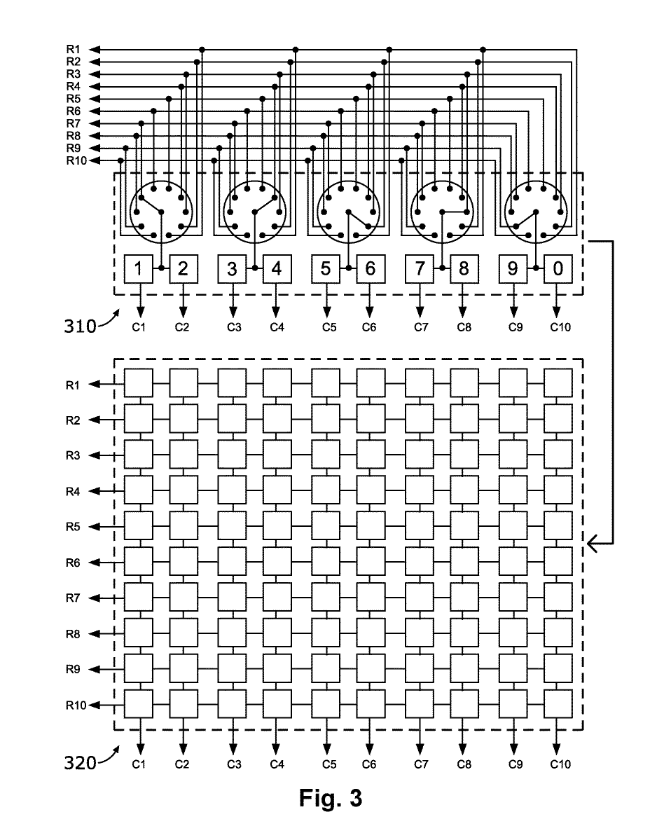

Step 2 is to build a key-mapping system with five 10-mode switches 120 in the keyboard. If the keyboard is a physical keyboard, the system comprises a circuit layout 310 equivalent to a 10×10 key matrix 320, as illustrated in FIG. 3. If the keyboard is an on-screen keyboard, the system has a background program. The key-mapping system in a physical keyboard or an on-screen keyboard sets up a 100-key character map, as shown in FIG. 2, that mixes all uppercase and lowercase letters, numbers and symbols to make any row of key character combinations met the requirements for generating strong passwords. Each pair of key characters 210 in the 100-key character map is assigned to one switch mode 220, so that a combination of ten strong password characters is configured when all modes of the five switches 120 are set.

Step 3 is to map the numeric password keys 110 to the configured combination of strong password characters 130 by setting the switch modes. To easily remember a setting of the switch modes and to make a unique combination of strong password characters, the switch modes are set by using five numbers associated to a user's personal confidential information. For example, to set the switch modes “69104” that can be the last five digits of a user's social security number, the system will configure a combination of key characters “Y%2s:˜5/Vr” that are mapped to the numeric password keys “1234567890”.

Step 4 is to input an actual strong password by typing a nominal easy-to-remember numeric password through the mapped numeric password keys on the keyboard. If setting the switch modes “69104”, as described above, a nominal “birthday” numeric password “19830627” will be converted to an actually entered strong password “YV/2r-%5” by using such a keyboard.

Hereinafter, exemplary embodiments of the invention will be described in detail with reference to the accompanying drawings.

### Embodiment 1

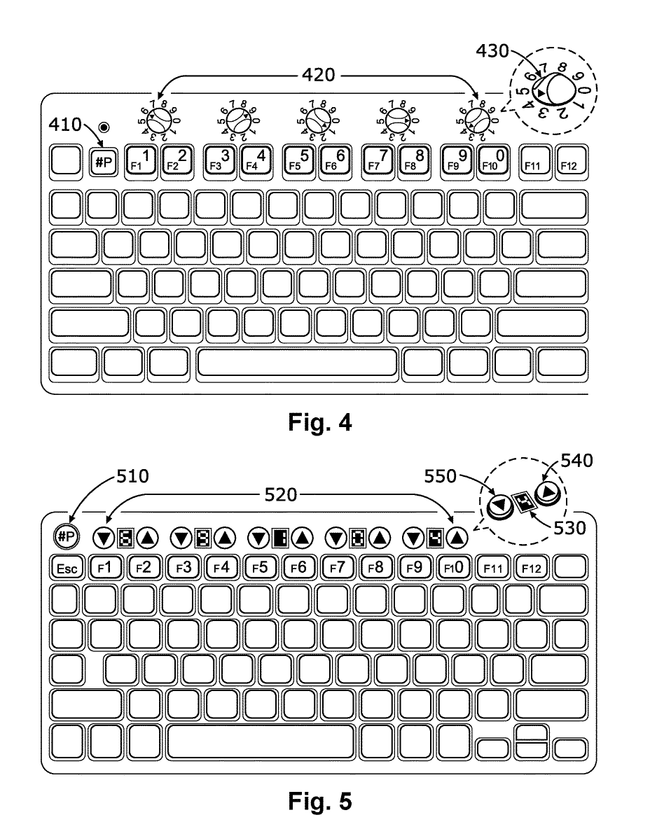

Referring to FIG. 4, one embodiment of the invention provides a standard keyboard with mechanical switches for inputting strong passwords. There is a row of numeric password keys 1-0 merged into the F1-F10 keys on the keyboard for typing nominal numeric passwords. The keyboard comprises a built-in key-mapping system for mapping the numeric password keys and a “#P” button 410 for activating or inactivating the system and the numeric password keys. The system has five 10-mode mechanical switches 420 installed above the F1-F10 keys, where each switch consists of a rotary knob 430 for setting its mode and ten mode numbers 1-0 around the knob for indicating a selected mode.

When inputting a strong password, a user firstly presses the “#P” button 410 to activate the system and the numeric password keys, secondly rotates each switch knob 430 to set each switch mode for configuring a combination of strong password characters that is mapped to the numeric password keys, and finally types an easy-to-remember numeric password through the mapped numeric password keys, so that the nominal numeric password is converted to an actually entered strong password. To clear the modes, the user can rotate each switch knob to a random position after completion of the password input.

One advantage of the embodiment is to use the F1-F10 keys as the numeric password keys for inputting strong passwords while keeping the main keyboard to function normally. And another one is to integrate the simple mechanical switches into the existing construction of physical keyboard for building a key-mapping system.

### Embodiment 2

Referring to FIG. 5, one embodiment of the invention provides a compact keyboard with digital switches for inputting strong passwords. There is a row of numeric password keys 1-0 merged into the F1-F10 keys on the keyboard for typing nominal numeric passwords. The keyboard comprises a built-in key-mapping system for mapping the numeric password keys and a “#P” button 510 for activating or inactivating the system and the numeric password keys. The system has five 10-mode digital switches 520 installed above the F1-F10 keys, where each switch consists of a single digit LCD 530 for displaying a selected mode and a pair of “up-arrow” and “down-arrow” setting buttons for adjusting the switch mode up and down when setting its mode.

When needing to input a strong password, a user firstly presses the “#P” button 510 to activate the system and the numeric password keys, secondly manipulates each pair of the “up-arrow” button 540 and the “down-arrow” button 550 to set each switch mode for configuring a combination of strong password characters that is mapped to the numeric password keys, and finally types an easy-to-remember numeric password through the mapped numeric password keys, so that the nominal numeric password is converted to an actually entered strong password. To clear the switch modes, the user can press both “#P” button 510 and “Esc” key after completion of the password input.

The advantage of using digital switches is to make keyboard compact. Furthermore, using digital switches can provide more options, such as programmable feature.

### Embodiment 3

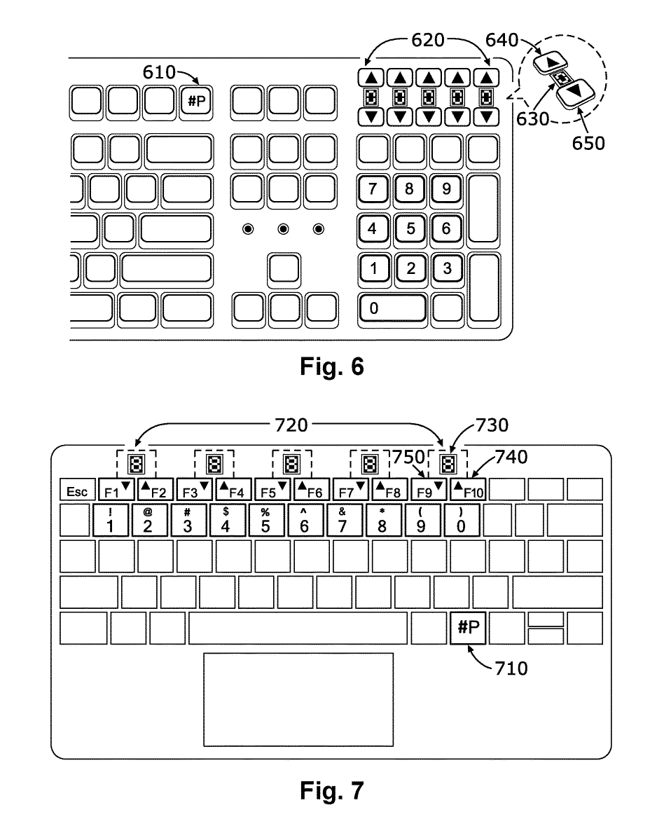

Referring to FIG. 6, one embodiment of the invention provides a keyboard with a configurable number keypad for inputting strong passwords. The number keys on the keypad are used as numeric password keys for typing nominal numeric passwords. The keyboard comprises a built-in key-mapping system for mapping the numeric password keys and a “#P” button 610 for activating or inactivating the system and the numeric password keys. The system has five 10-mode digital switches 620 installed above the number keypad, where each switch consists of a single digit LCD 630 for displaying a selected mode and a pair of “up-arrow” and “down-arrow” setting buttons for adjusting the mode setting.

When needing to input a strong password, a user firstly presses the “#P” button 610 to activate the system and the numeric password keys, secondly manipulates each pair of the “up-arrow” button 640 and the “down-arrow” button 650 to set each switch mode for configuring a combination of strong password characters that is mapped to the numeric password keys, and finally types an easy-to-remember numeric password through the mapped numeric password keys, so that the nominal numeric password is converted to an actually entered strong password. To clear the switch modes, the user can press both “#P” button 610 and “Esc” key after completion of the password input.

The advantage of integrating the digital switches into the number keypad on the keyboard is able to separate the key-mapping system from the main keyboard.

### Embodiment 4

Referring to FIG. 7, one embodiment of the invention provides a laptop keyboard with digital switches for inputting strong passwords. The row of number keys 1-0 on the laptop keyboard is used as numeric password keys for typing nominal numeric passwords. The keyboard comprises a built-in key-mapping system for mapping the numeric password keys and a “#P” button 710 for activating or inactivating the system and the numeric password keys. The system has five 10-mode digital switches 720 installed above the F1-F10 function keys, where each switch consists of a single digit LCD 730 for displaying a selected mode and a pair of “up-arrow” and “down-arrow” setting buttons for setting its mode. The setting buttons are merged into the F1-F10 keys and used for adjusting each switch mode up and down when setting the switch modes.

When needing to input a strong password, a user firstly presses the “#P” button 710 to activate the system and the numeric password keys, secondly manipulates each pair of the “up-arrow” button 740 and the “down-arrow” button 750 to set each switch mode for configuring a combination of strong password characters that is mapped to the numeric password keys, and finally types an easy-to-remember numeric password through the mapped numeric password keys, so that the nominal numeric password is converted to an actually entered strong password. To clear the switch modes, the user can press both “#P” button 710 and “Esc” key after completion of the password input.

The advantage of the embodiment is to use the F1-F10 keys as the switch setting buttons, so that the thin LCD displays can be perfectly fitted into a thin keyboard.

### Embodiment 5

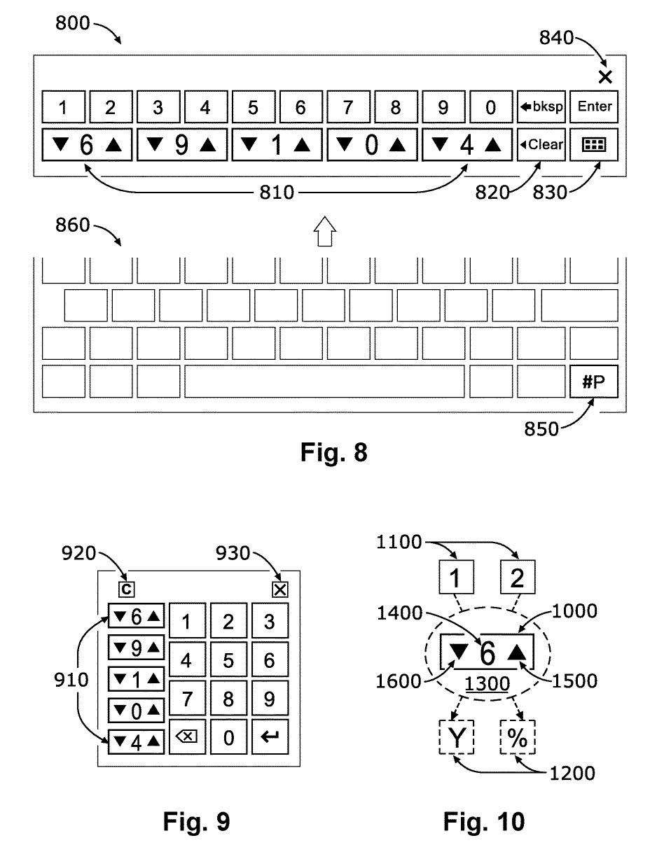

Referring to FIG. 8, one embodiment of the invention provides an on-screen numeric password keyboard for inputting strong passwords. The keyboard 800 has a row of numeric password keys 1-0 for typing nominal numeric passwords and a key-mapping system for mapping the numeric password keys. The key-mapping system comprises a row of five 10-mode switches 810 and a background program, where each switch 1000, as depicted in FIG. 10, is set to map two associated numeric password keys 1100 to two configured key characters 1200 through the background program 1300. And each switch 1000 consists of a mode number 1400 in the middle of the switch for displaying a selected mode and a pair of “up-arrow” and “down-arrow” setting buttons for adjusting the switch mode up and down when setting the switch mode. There is a “Clear” button 820 and “Keyboard” button 830 in the second row of the keyboard and a closing button “X” 840 on right upper corner of the keyboard.

When needing to input a strong password, a user firstly clicks a “#P” button 850 on an on-screen typing keyboard 860 to shift to the on-screen numeric password keyboard 800, secondly clicks the “up-arrow” button 1500 or the “down-arrow” button 1600 to set each switch mode for configuring a combination of strong password characters that is mapped to the numeric password keys through the background program, and finally types a nominal easy-to-remember numeric password that is converted to an actually entered strong password. After completion of the password input, the user can click the “Clear” button 820 to clear the switch modes for security purpose, and click the “X” button 840 to close the on-screen numeric password keyboard and to save the last setting of the switch modes, or click the “Keyboard” button 830 to return to the previous on-screen typing keyboard 860.

The advantage of the on-screen numeric password keyboard is easy to use. It is more beneficial for users if the keyboard is configured with a user's defined unique key character map that makes a password much harder to be hacked. And to use the keyboard with a unique key character map for inputting a password can prevent the password from being hacked by key logging.

### Embodiment 6

Referring to FIG. 9, one embodiment of the invention provides an on-screen numeric password keyboard for inputting strong passwords. The keyboard has a matrix of numeric password keys for typing nominal numeric passwords and a key-mapping system for mapping the numeric password keys. The key-mapping system comprises a column of five 10-mode switches 910 and a background program, where each switch 1000, as depicted in FIG. 10, is set to map two associated numeric password keys 1100 to two configured key characters 1200 through the background program 1300. And each switch 1000 consists of a mode number 1400 in the middle of the switch for displaying a selected mode and a pair of “up-arrow” and “down-arrow” setting buttons for adjusting the switch mode up and down when setting the switch mode. There are a clearing button “C” 920 on the left upper corner of the keyboard and a closing button “X” 930 on the right upper corner of the keyboard.

When needing to input a strong password, a user firstly clicks a “#P” button on the taskbar of an operating system to turn on the on-screen numeric password keyboard, secondly clicks the “up-arrow” button 1500 or the “down-arrow” button 1600 to set each switch mode for configuring the strong password characters that is mapped to the numeric password keys through a background program, and finally types a nominal easy-to-remember numeric password that is converted to an actually entered strong password. After completion of the password input, the user can click the “C” button 920 to clear the switch modes, and click the “X” button 930 to close the on-screen password numeric keyboard and to save the last setting of the switch modes.

The advantage of the on-screen numeric password keyboard is to use a matrix layout that is suitable for small screen devices, such as a mobile phone.

While the foregoing written description of the invention enables one of ordinary skill to make and use what is considered presently to be the best mode thereof, those of ordinary skill will understand and appreciate the existence of variations, combinations, and equivalents of the specific embodiment and method herein. The invention should therefore not be limited by the above described embodiments and methods, but by all embodiments and methods within the scope and spirit of the invention.

I claim:

1. A method for inputting a strong password through a keyboard, the method comprising:
having a set of numeric password keys on the keyboard for typing a nominal easy-to-remember numeric password that is converted to an actual strong password;
building a key-mapping system with five 10-mode switches in the keyboard for configuring a combination of strong password characters by setting the switch modes;
mapping the numeric password keys to the configured combination of strong password characters when the switch modes are set by using five numbers associated to a user's personal confidential information; and
inputting an actual strong password by typing a nominal easy-to-remember numeric password through the mapped numeric password keys on the keyboard.

2. The built-in key-mapping system with five 10-mode switches, as recited in claim 1, the system comprising:
a circuit layout equivalent to a 10×10 key matrix in a physical keyboard or a background program of an on-screen numeric password keyboard for setting up a 100-key character map;
wherein the preset 100-key character map mixes all uppercase and lowercase letters, numbers and symbols to make any row of key character combinations met the requirements for generating strong passwords;
wherein each pair of characters in the map is assigned to one switch mode, so that ten password characters is configured for mapping the numeric password keys when the five switch modes are set.

3. A standard keyboard with mechanical switches for implementing the method of claim 1, the keyboard comprising:
a set of numeric password keys merged into the F1-F10 function keys on the keyboard for typing a nominal easy-to-remember numeric password that is converted to an actually entered strong password; and
a built-in key-mapping system with five 10-mode mechanical switches installed above the F1-F10 keys for configuring a combination of strong password characters that is mapped to the numeric password keys when the switch modes are set;
wherein each switch consists of a rotary knob for setting the switch mode and ten mode numbers around the knob for indicating a selected mode.

4. A compact keyboard with digital switches for implementing the method of claim 1, the keyboard comprising:
a set of numeric password keys merged into the F1-F10 function keys on the keyboard for typing a nominal easy-to-remember numeric password that is converted to an actually entered strong password; and
a built-in key-mapping system with five 10-mode digital switches installed above the F1-F10 keys for configuring a combination of strong password characters that is mapped to the numeric password keys when the switch modes are set;
wherein each switch consists of a single digit LCD for displaying a selected mode and a pair of setting buttons for setting the switch mode.

5. A keyboard with a configurable number keypad for implementing the method of claim 1, the keyboard comprising:
the number keys on the number keypad used as numeric password keys for typing a nominal easy-to-remember numeric password that is converted to an actually entered strong password; and
a built-in key-mapping system with five 10-mode digital switches installed above the number keypad for configuring a combination of strong password characters that is mapped to the numeric password keys when the switch modes are set;
wherein each switch consists of a single digit LCD for displaying a selected mode and a pair of setting buttons for setting the switch mode.

6. A laptop keyboard with digital switches for implementing the method of claim 1, the keyboard comprising:
the row of number keys on the keyboard used as numeric password keys for typing a nominal easy-to-remember numeric password that is converted to an actually entered strong password; and
a built-in key-mapping system with five 10-mode digital switches installed above the F1-F10 keys on the keyboard for configuring a combination of strong password characters that is mapped to the numeric password keys when the switch modes are set;
wherein each switch consists of a single digit LCD for displaying a selected mode and a pair of setting buttons merged into two associated function keys under the LCD for setting the switch mode.

7. An on-screen numeric password keyboard for implementing the method of claim 1, the keyboard comprising:
a row of numeric password keys for typing a nominal easy-to-remember numeric password that is converted to an actually entered strong password; and
a row of five 10-mode switches of the key-mapping system, as recited in claim 2, for configuring a combination of strong password characters that is mapped to the numeric password keys when the switch modes are set.

8. An on-screen numeric password keyboard for implementing the method of claim 1, the keyboard comprising:
a matrix of numeric password keys for typing a nominal easy-to-remember numeric password that is converted to an actually entered strong password; and
a column of five 10-mode switches of the key-mapping system, as recited in claim 2, for configuring a combination of strong password characters that is mapped to the numeric password keys when the switch modes are set.

9. The five 10-mode switches, as recited in claim 7-8, wherein each switch comprises a mode number in the middle of the switch for displaying a selected mode and a pair of setting buttons for setting its mode in order to configure two characters for mapping two associated numeric password keys through the background program of the key-mapping system.
